(19) United States
(12) Patent Application Publication
(10) Pub. No.: US 2025/0252462 A1
(43) Pub. Date: Aug. 7, 2025

(54) SYSTEMS AND METHODS FOR MODIFYING CAMPAIGN ITEMS

(71) Applicant: INDEX WEB MARKETING INC., Montreal (CA)

(72) Inventors: Jeremy EASTERBROOK, Montreal (CA); Andre Renato RIZZO DIAS, Coteau du Lac (CA); Arianne MATTE, Verdun (CA); Pierre Christophe Henri JEAN, Montréal (CA)

(21) Appl. No.: 19/047,723

(22) Filed: Feb. 7, 2025

Related U.S. Application Data
(60) Provisional application No. 63/550,649, filed on Feb. 7, 2024.

(51) Int. Cl. G06Q 30/0241; G06N 20/20

(52) U.S. Cl. CPC G06Q 30/0276; G06N 20/20

(57) ABSTRACT

There is disclosed a method and system for modifying campaign items. Data corresponding to a campaign item may be retrieved. The data may be input to a first machine learning algorithm (MLA) trained to predict a type of change to a campaign item. A first prediction that indicates a type of change to for the campaign item may be received from the first MLA. The data corresponding to the campaign item and the first prediction may be input to a second MLA that was trained to predict a magnitude of the type of change to the campaign item. The second MLA may output a second prediction that indicates a magnitude corresponding to the first prediction. A user interface may be output that includes the first prediction and the second prediction as a recommendation.

### CROSS-REFERENCE TO RELATED APPLICATION

This application claims the benefit of U.S. Provisional Patent Application No. 63/550,649, filed on Feb. 7, 2024, which is incorporated by reference herein in its entirety.

### FIELD

The present technology relates to systems and methods for training and using machine learning algorithms for modifying marketing campaign items and optimizing marketing campaigns.

### BACKGROUND

A marketing campaign, such as an internet advertising campaign, may include numerous campaign items. Periodically, such as weekly, the campaign items may be reviewed and adjusted. These adjustments may be made by human operators. The human operator may review information about past performance of the campaign item and, based on that information, adjust various aspects of the campaign item. This process of manually adjusting the campaign item may be time-consuming, difficult, and the results may rely on the experience and skill of the human operator.

It is an object of the present technology to ameliorate at least some of the limitations present in the prior art.

### SUMMARY

Implementations of the present technology have been developed based on developers' appreciation of shortcomings associated with the prior art.

According to a first broad aspect of the present technology, there is provided a method comprising: retrieving data corresponding to a campaign item; inputting the data corresponding to the campaign item to a first machine learning algorithm (MLA), wherein the first MLA was trained to predict a type of change to a campaign item based on first labelled campaign item data, wherein each data point in the first labelled campaign item data comprises data corresponding to a campaign item and a label comprising a categorical value indicating a type of change made to the campaign item; receiving, from the first MLA, a first prediction, wherein the first prediction indicates a type of change for the campaign item; inputting the data corresponding to the campaign item and the first prediction to a second MLA, wherein the second MLA was trained to predict a magnitude of the type of change to the campaign item based on second labelled campaign item data, wherein each data point in the second labelled campaign item data comprises data corresponding to a campaign item and a label comprising a numerical value indicating an amplitude of a change to the campaign item; receiving, from the second MLA, a second prediction, wherein the second prediction indicates a magnitude corresponding to the first prediction; outputting, to a user interface, the first prediction and the second prediction for display as a recommended action for the campaign item; receiving, via the user interface, user input indicating whether the user has accepted the recommended action, rejected the recommended action, or modified the recommended action; modifying the user interface based on the user input; and applying, to the campaign item, changes from the user input.

In some implementations of the method, the method further comprises: generating an additional training data point based on the user input; and further training the first MLA and the second MLA using the additional training data point.

In some implementations of the method, retrieving the data corresponding to the campaign item comprises retrieving a number of clicks, a total cost, a number of impressions, and a number of conversions.

In some implementations of the method, the first MLA and the second MLA comprise neural networks.

In some implementations of the method, the categorical value of the label indicates that: no changes were made to the campaign item, a new similar campaign item was created, the campaign item was paused, a budget of the campaign item was increased, or the budget was decreased.

In some implementations of the method, the numerical value of the label indicates an amount that the campaign item budget was increased or decreased.

According to another broad aspect of the present technology, there is provided a method comprising: retrieving data corresponding to a campaign item; inputting the data corresponding to the campaign item to a machine learning algorithm (MLA), wherein the MLA was trained to predict a type of change to a campaign item based on labelled campaign item data, wherein each data point in the labelled campaign item data comprises data corresponding to a campaign item and a label comprising a categorical value indicating a type of change made to the campaign item; receiving, from the MLA, a prediction indicating a type of change for the campaign item; outputting, to a user interface, the prediction for display as a recommended action for the campaign item; receiving, via the user interface, user input indicating whether the user has accepted the recommended action, rejected the recommended action, or modified the recommended action; modifying the user interface based on the user input; and applying, to the campaign item, changes from the user input.

According to another broad aspect of the present technology, there is provided a system comprising at least one processor and memory storing a plurality of executable instructions which, when executed by the at least one processor, cause the system to perform a method comprising: retrieving data corresponding to a campaign item; inputting the data corresponding to the campaign item to a first machine learning algorithm (MLA), wherein the first MLA was trained to predict a type of change to a campaign item based on first labelled campaign item data, wherein each data point in the first labelled campaign item data comprises data corresponding to a campaign item and a label comprising a categorical value indicating a type of change made to the campaign item; receiving, from the first MLA, a first prediction, wherein the first prediction indicates a type of change for the campaign item; inputting the data corresponding to the campaign item and the prediction to a second MLA, wherein the second MLA was trained to predict a magnitude of the type of change to the campaign item based on second labelled campaign item data, wherein each data point in the second labelled campaign item data comprises data corresponding to a campaign item and a label comprising a numerical value indicating an amplitude of a change to the campaign item; receiving, from the second MLA, a second prediction, wherein the second prediction indicates a magnitude corresponding to the first prediction; outputting, to a user interface, the first prediction and the second prediction for display as a recommended action for the campaign item; receiving, via the user interface, user input indicating whether the user has accepted the recommended action, rejected the recommended action, or modified the recommended action; modifying the user interface based on the user input; and applying, to the campaign item, changes from the user input.

According to another broad aspect of the present technology, there is provided a non-transitory computer-readable medium comprising computer-readable instructions that, upon being executed by at least one processor, cause the at least one processor to perform a method comprising: retrieving data corresponding to a campaign item; inputting the data corresponding to the campaign item to a first machine learning algorithm (MLA), wherein the first MLA was trained to predict a type of change to a campaign item based on first labelled campaign item data, wherein each data point in the first labelled campaign item data comprises data corresponding to a campaign item and a label comprising a categorical value indicating a type of change made to the campaign item; receiving, from the first MLA, a first prediction, wherein the first prediction indicates a type of change for the campaign item; inputting the data corresponding to the campaign item and the prediction to a second MLA, wherein the second MLA was trained to predict a magnitude of the type of change to the campaign item based on second labelled campaign item data, wherein each data point in the second labelled campaign item data comprises data corresponding to a campaign item and a label comprising a numerical value indicating an amplitude of a change to the campaign item; receiving, from the second MLA, a second prediction, wherein the second prediction indicates a magnitude corresponding to the first prediction; outputting, to a user interface, the first prediction and the second prediction for display as a recommended action for the campaign item; receiving, via the user interface, user input indicating whether the user has accepted the recommended action, rejected the recommended action, or modified the recommended action; modifying the user interface based on the user input; and applying, to the campaign item, changes from the user input.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a block diagram of an example computing environment in accordance with various embodiments of the present technology;

FIG. 2 is a block diagram of a system for managing a marketing campaign in accordance with various embodiments of the present technology;

FIGS. 3 and 4 are a flow diagram of a method for modifying a campaign item in accordance with various embodiments of the present technology;

FIG. 5 illustrates training data for training machine learning algorithms for managing a marketing campaign in accordance with various embodiments of the present technology;

FIG. 6 is a flow diagram of a method for training machine learning algorithms for managing a marketing campaign in accordance with various embodiments of the present technology;

FIG. 7 illustrates a user interface for reviewing recommendations and managing a marketing campaign in accordance with various embodiments of the present technology; and

FIG. 8 illustrates the user interface after selections have been made for managing the marketing campaign in accordance with various embodiments of the present technology.

It should be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and/or implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some implementations of the present technology, the processor may be a general purpose processor, such as a central processing unit (CPU) or a processor dedicated to a specific purpose, such as a digital signal processor (DSP) or quantum processing unit (QPU). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof.

In the context of the present specification, unless expressly provided otherwise, a computer system may refer, but is not limited to, an “electronic device,” an “operation system,” a “system,” a “computer-based system,” a “controller unit,” a “monitoring device,” a “control device,” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives. Still in the context of the present specification, “a” computer-readable medium and “the” computer-readable medium should not be construed as being the same computer-readable medium. To the contrary, and whenever appropriate, “a” computer-readable medium and “the” computer-readable medium may also be construed as a first computer-readable medium and a second computer-readable medium.

In the context of the present specification, unless expressly provided otherwise, the words “first,” “second,” “third,” etc. have been used as adjectives only for the purpose of allowing for distinction between the nouns that they modify from one another, and not for the purpose of describing any particular relationship between those nouns.

With these fundamentals in place, we will now consider some non-limiting examples of the present technology.

### Computing Environment

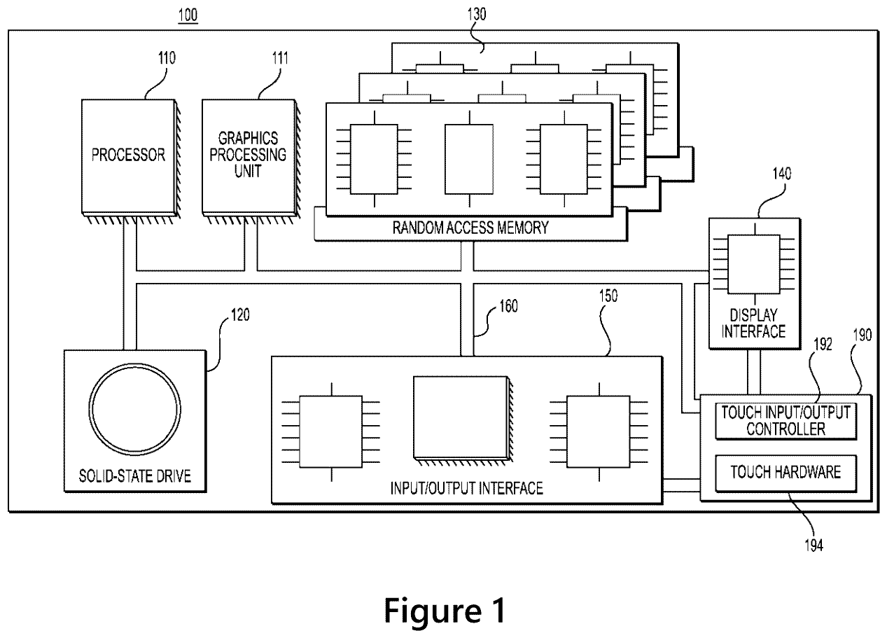

FIG. 1 illustrates a computing environment 100, which may be used to implement and/or execute any of the methods described herein. In some embodiments, the computing environment 100 may be implemented by any of a conventional personal computer, a network device, and/or an electronic device (such as, but not limited to, a mobile device, a tablet device, a server, a controller unit, a control device, etc.), and/or any combination thereof appropriate to the relevant task at hand.

In some embodiments, the computing environment 100 comprises various hardware components including one or more single or multi-core processors collectively represented by processor 110, a solid-state drive 120, a random access memory 130, and an input/output interface 150. The computing environment 100 may be a computer specifically designed to operate a machine learning algorithm (MLA). The computing environment 100 may be a generic computer system.

In some embodiments, the computing environment 100 may also be a subsystem of one of the above-listed systems. In some other embodiments, the computing environment 100 may be an “off-the-shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Those skilled in the art will appreciate that processor 110 is generally representative of a processing capability. In some embodiments, in place of or in addition to one or more conventional Central Processing Units (CPUs), one or more specialized processing cores may be provided. For example, one or more Graphic Processing Units 111 (GPUs), Quantum Processing Units (QPUs), Tensor Processing Units (TPUs), and/or other so-called accelerated processors (or processing accelerators) may be provided in addition to or in place of one or more CPUs.

System memory will typically include random access memory 130, but is more generally intended to encompass any type of non-transitory system memory such as static random access memory (SRAM), dynamic random access memory (DRAM), synchronous DRAM (SDRAM), read-only memory (ROM), or a combination thereof. Solid-state drive 120 is shown as an example of a mass storage device, but more generally such mass storage may comprise any type of non-transitory storage device configured to store data, programs, and other information, and to make the data, programs, and other information accessible via a system bus 160. For example, mass storage may comprise one or more of a solid state drive, hard disk drive, a magnetic disk drive, and/or an optical disk drive.

Communication between the various components of the computing environment 100 may be enabled by a system bus 160 comprising one or more internal and/or external buses (e.g., a PCI bus, universal serial bus, IEEE 1394 “Firewire” bus, SCSI bus, Serial-ATA bus, ARINC bus, etc.), to which the various hardware components are electronically coupled.

The input/output interface 150 may enable networking capabilities such as wired or wireless network communications. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example the networking interface may implement specific physical layer and data link layer standards such as Ethernet, Fibre Channel, Wi-Fi, Token Ring or Serial communication protocols. The specific physical layer and the data link layer may provide a base for a full network protocol stack, allowing communication among small groups of computers on the same local area network (LAN) and large-scale network communications through routable protocols, such as Internet Protocol (IP).

The input/output interface 150 may be coupled to a touchscreen 190 and/or to the one or more internal and/or external buses 160. The touchscreen 190 may be part of the display. In some embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computing environment 100 in addition to or instead of the touchscreen 190.

According to some implementations of the present technology, the solid-state drive 120 stores program instructions suitable for being loaded into the random access memory 130 and executed by the processor 110 for executing acts of one or more methods described herein. For example, at least some of the program instructions may be part of a library or an application.

The computing environment 100 may include any number of the illustrated components, which may be integrated in any number of physical devices. The computing environment 100 may be implemented as a cloud environment and/or a distributed architecture. The computing environment 100 may include multiple servers, which may be in different physical locations and/or on different networks. The computing environment 100 may include virtualized systems. The methods described herein, or any parts of the methods described herein, may be executed on multiple systems as distributed applications.

### System for Managing a Campaign

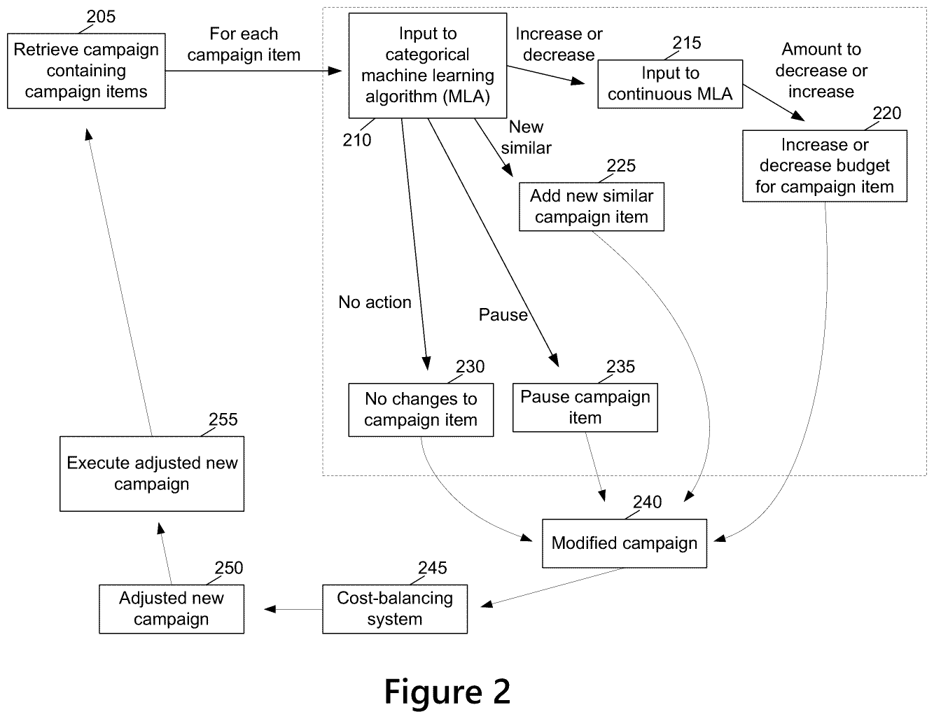

FIG. 2 is a block diagram of a system for managing a marketing campaign in accordance with various embodiments of the present technology. At block 205 a campaign containing any number of campaign items may be retrieved and/or accessed. The campaign may be an internet advertising campaign, such as an advertising campaign implemented on Google Ads®, Meta Business®, LinkedIn®, Amazon Ads®, and/or any other online advertising platform. The campaign items may include advertisements with images, audio, video, text, and/or any other type of advertising. The advertisements may be displayed to viewers, who may be users of a website, users of a mobile application, viewers of media, such as streaming audio and/or video, viewers of print media, and/or any viewers of any other type of content and/or advertising.

The campaign retrieved at block 205 may include information about how each campaign item has performed. The information about a campaign item may include: a campaign identifier, a campaign name, an identification of one or more parents of the campaign item, a date and/or time at which the campaign item was launched, a last edited date and/or time, a number of impressions that the campaign item has received, a number of clicks on the campaign item, a cost per click, a number of conversions for the campaign item, a cost per conversion, a conversion value, a total cost of the campaign item, and/or any other information about the campaign item. The information about the campaign item may correspond to a specified time period, for example the information about the campaign item may include a number of clicks that the campaign item received in the past thirty days, a number of clicks received in the past seven days, and a number of clicks that the campaign item received in the past day.

Each campaign item may be input to a categorical machine learning algorithm (MLA) at block 210. The categorical MLA may have been trained to determine an action to be applied to the campaign item. The categorical MLA may have been trained to predict an action that a human operator would take when reviewing the campaign item and/or improve the performance of the campaign item. The categorical MLA may use some or all of the information about the campaign item to generate a recommended action.

The categorical MLA may output a recommendation to increase the budget of the campaign item, decrease the budget of the campaign item, create a new similar campaign item, pause the campaign item, take no action on the campaign item (i.e. make no changes to the campaign item), and/or any other action. The categorical MLA may output the recommendation as an array having a value for each of the potential actions. The value for each action may indicate a predicted likelihood that a human operator, after reviewing the performance of the campaign item, would select that action.

The next steps performed by the system illustrated in FIG. 2 may depend on the output of the categorical MLA at block 210. If the recommendation output by the categorical MLA at block 210 is to increase or decrease the budget, the output of the categorical MLA and/or other information about the campaign item may be input to the continuous MLA at block 215. The continuous MLA may have been trained to predict an amount that the human operator would select to increase or decrease the budget.

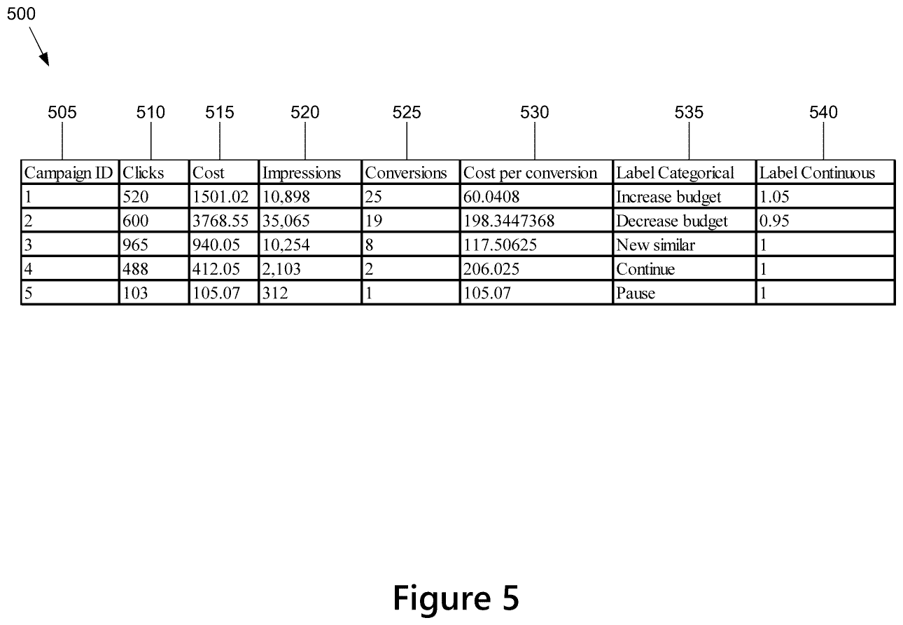

The categorical MLA at block 210 may have a categorical output, such as one action from a set of possible actions, or a predicted likelihood for each of the possible actions. The continuous MLA at block 215 may have a continuous output, such as a percentage to increase or reduce the budget for the campaign item. FIG. 5 illustrates an example of training data that may be used for training the categorical MLA and/or the continuous MLA. The categorical MLA and the continuous MLA may be any type of machine learning algorithm, such as a neural network.

The continuous MLA may output the value to increase or decrease the budget to block 220. At block 220, the budget for the campaign item may be increased and/or decreased based on the amount output by the continuous MLA. Although described herein as increasing or decreasing a budget for a campaign item, it should be understood that any other actions to increase or decrease the cost associated with a campaign item may be taken, such as increasing or decreasing a bid price associated with the campaign item. The campaign item, as modified, may be included in the modified campaign at block 240.

If, at block 210, the categorical MLA recommends that a new similar campaign item be generated, the system illustrated in FIG. 2 may proceed to block 225. At block 225 a new similar campaign item may be generated and then added to the modified campaign item at block. The new similar campaign item may have some or all of the same settings as the original campaign item. The new similar campaign item may change some aspects of the original campaign item, such as a different font, different background color, different text or image, and/or any other changes to the original campaign item. The original campaign item may be preserved, in which case both the new similar campaign item and the original campaign item (with no changes) may be included in the modified campaign at block 240.

If the categorical MLA outputs a recommendation to pause the campaign item, the campaign item may be paused at block 235 and then the paused campaign item may be included in the modified campaign at block 240. A paused campaign item may be restarted at some time in the future. The advertisement corresponding to the paused campaign item might not be displayed to viewers until the campaign item is reactivated. No costs may be incurred for the campaign item while the campaign item is paused.

If the categorical MLA outputs a recommendation to take no action on the campaign item, at block 230 no changes may be made to the campaign item. The campaign item, with no changes, may be included in the modified campaign at block 240.

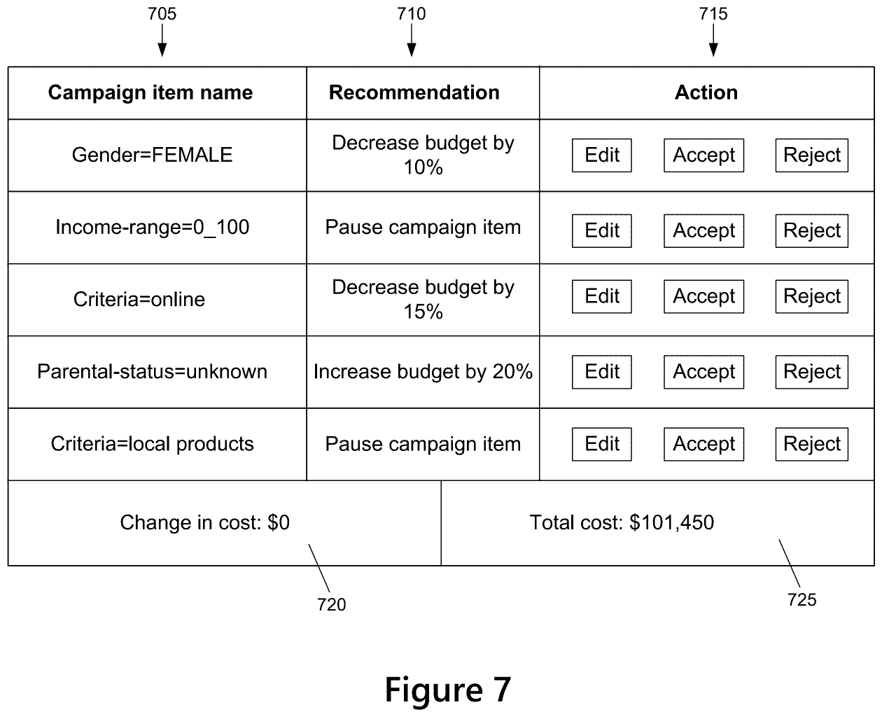

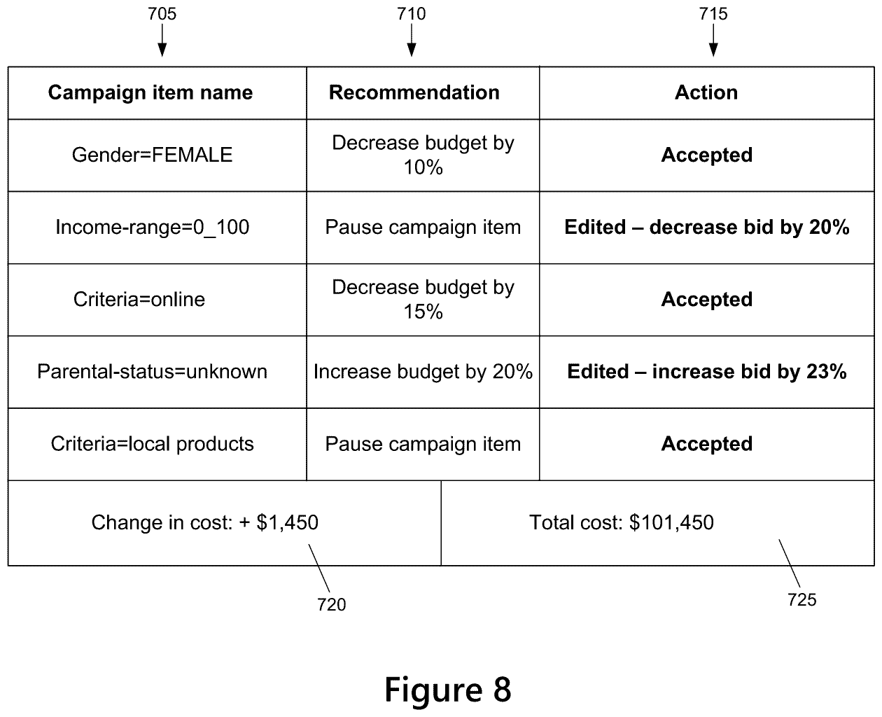

The actions performed at blocks 220, 225, 230, and 235 may be performed automatically or manually by a human operator. In an automatic system, the changes recommended by the categorical MLA at block 210 and/or continuous MLA at block 215 may be automatically applied to the advertising campaign in order to generate the modified campaign at block 240. In a manual system, the changes recommended by the categorical MLA at block 210 and/or continuous MLA at block 215 may be output to a human operator in a user interface. The human operator may then accept a recommendation and apply the suggested change to the campaign item, modify the recommendation and apply the modified change to the campaign item, and/or reject the recommendation in which case the campaign item is left unchanged. An example of a user interface with recommendations is illustrated in FIGS. 7 and 8.

After each campaign item has been input to the categorical MLA at block 210 and the modified campaign has been generated at block 240, a cost-balancing system may further adjust the campaign at block 245. The cost-balancing system may adjust the budget for individual campaign items in order to meet an overall budget for the campaign. The cost-balancing system may output an adjusted new campaign at block 250. This adjustment may be informed by a quadratic regression model that effectively captures the non-linear relationship between bid adjustments and cost changes. Utilizing historical data, this model predicts the impact of bid adjustments on overall costs, enabling the system to normalize the budget for each campaign item when bid adjustments are made. Consequently, this approach may ensure that the overall campaign remains within its allocated budget while optimizing the performance of each campaign item, regardless of the non-linear nature of cost changes associated with bid adjustments.

The cost-balancing system may calculate the cost of the modified campaign. The cost of the modified campaign may be compared to a desired cost, such as the cost of the original campaign, a desired cost input by a user, or any other desired amount. If the cost of the modified campaign is higher or lower than the desired cost, the cost-balancing system may make changes to campaign items in the modified campaign.

The cost-balancing system may sort the campaign items based on a criteria, such as the cost of the campaign items, predicted increase in performance of the campaign items, and/or any other criteria. The individual campaign items may then be adjusted based on their order in the list until the cost of the modified campaign matches the desired budget.

The adjusted new campaign may then be executed at block 255. The adjusted new campaign may be initiated at an online advertising platform at block 255, such as by applying the changes to a Google Ads® campaign.

The adjusted new campaign may be executed at block 255 for any amount of time, such as one day, one week, one month, etc. until it is retrieved at block 205 and each campaign item is again reviewed and/or modified using the system illustrated in FIG. 2. In this manner the campaign is periodically and/or continuously adjusted based on the performance of individual campaign items. The categorical MLA and/or continuous MLA may be periodically and/or continuously re-trained based on the performance of the campaign items and/or whether the recommendations that were output were accepted by a human operator.

### Method for Modifying Campaign Items

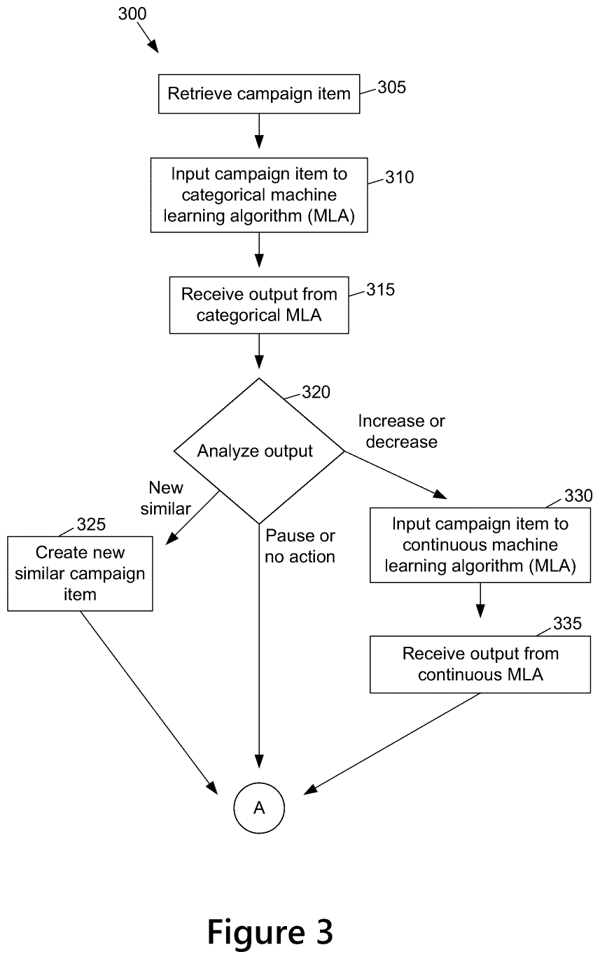

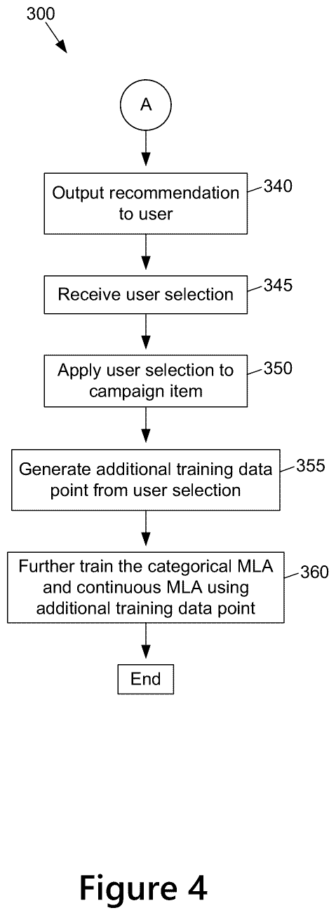

FIGS. 3 and 4 are a flow diagram of a method 300 for modifying a campaign item in accordance with various embodiments of the present technology. In one or more aspects, the method 300 or one or more steps thereof may be performed by a computing system, such as the computing environment 100. The method 300 or one or more steps thereof may be embodied in computer-executable instructions that are stored in a computer-readable medium, such as a non-transitory mass storage device, loaded into memory and executed by a CPU. The method 300 is exemplary, and it should be understood that some steps or portions of steps in the flow diagram may be omitted and/or changed in order.

At step 305 a campaign item may be retrieved. The campaign item may be accessed on an online advertising portal, such as a Google Ads® account and/or any other online advertising portal. Information about an entire campaign may be retrieved. The information may be retrieved in any suitable format, such as in a spreadsheet format or comma separated value format. The information may be retrieved by any suitable means, such as by performing database queries. Information about individual campaign items may then be extracted from the information about the entire campaign.

The information about the campaign item may include information about the advertisement corresponding to the campaign item, such as a name of the campaign item, other campaign items that the campaign item is related to, an advertisement corresponding to the campaign item, information about which services are outputting the campaign item to viewers (such as search engines, websites, etc.). The information about the campaign item may include various targeted dimensions of the campaign item, such as a geographical area that the campaign item is targeted at, an age range that the campaign item is targeted at, a gender that the campaign item is targeted at, and/or any other dimensions of the campaign item.

The information retrieved at step 305 may include performance information about the campaign item, such as a number of clicks, number of impressions, number of conversions, total cost, cost per click, cost per impression, cost per conversions, conversion value, and/or any other performance information about the campaign item. Each of these performance values may correspond to a specified time period, such as the past thirty days, past week, past day, etc. For example the performance values may include a number of clicks in the past day, a number of clicks in the past seven days, a number of clicks in the past thirty days, a cost for the past day, a cost for the past seven days, a cost for the past thirty days, a number of impressions for the past day, a number of impressions for the past seven days, a number of impressions for the past thirty days, a number of conversions for the past day, a number of conversions for the past seven days, and/or a number of conversions for the past thirty days.

The information retrieved about the campaign item may depend on the online advertising platform that the campaign is hosted on, as different advertising platforms may provide different information. Any performance information provided by the advertising platform may be retrieved. Additional performance information may also be calculated based on the retrieved data.

At step 310 the information retrieved and/or generated at step 305 may be input to a categorical MLA, such as the categorical MLA described at block 210 of FIG. 2. As described above, the categorical MLA may output a categorical recommendation, such as a recommendation to increase the budget of the campaign item, decrease the budget of the campaign item, pause the campaign item, make no changes to the campaign item, and/or generate a new similar campaign item.

The categorical MLA may be any type of machine learning algorithm, such as a neural network. The neural network may be a deep neural network (DNN). The neural network may be a neural network configured to receive tabular data, such as TabNet. TabNet, specifically designed for tabular data, utilizes a unique feature: masked attention. This attention mechanism allows the model to selectively focus on specific features of the input data, effectively learning which features are most important for the task at hand. The masked attention in TabNet works by sequentially applying masks to the input features, enabling the network to make decisions at each step based on a subset of the features. This approach is in contrast to traditional DNNs that consider all features simultaneously. The selective attention mechanism of TabNet allows it to learn complex interactions between features while maintaining interpretability, as it becomes clear which features are being used for predictions at each decision step. The neural network may be trained using a gradient descent-based optimization.

The categorical MLA may be trained using a set of training data points. Each training data point may include information about a campaign item from a previous campaign. The training data points may be generated when an operator makes changes to the campaign. A training data point may include the values that the operator reviewed when making the changes, such as performance values of the campaign item. These values may be referred to as “features.” Each training data point may also include a label, which may be referred to as a “target.” The label may indicate an action that was executed by a human operator on the campaign item. For example, if the human operator chose to increase the budget of the campaign item, the label may indicate that the budget for the campaign item was increased.

The categorical MLA may be trained to use the features for a campaign item to predict the label for the campaign item. Each time a training data point is input to the categorical MLA, the categorical MLA may determine a predicted action to be taken on the campaign item. The predicted action may be compared to the label, and an amount of loss may be calculated indicating whether the prediction was correct or incorrect and/or how correct or incorrect the prediction was. The categorical MLA may then be adjusted based on the loss value, so that if presented with the same training data point again the categorical MLA would output a prediction that is closer to the label. This process may be repeated numerous times in order to train the categorical MLA.

At step 310 the categorical MLA may process the features of the campaign item that were input, such as the performance information, and then output a categorical output at step 315. The categorical output may indicate a predicted likelihood for each of the available categories. The predicted likelihood may indicate a likelihood that a human operator would choose each of the available categories for the campaign item. For example the output for a campaign item may indicate that a human operator would be 5% likely to select increasing the budget, 25% likely to select decreasing the budget, 50% likely to select pausing the campaign item, 8% likely to select create a new similar campaign item, and 12% likely to select no modification to the campaign item. The output of the categorical MLA at step 315 may include a predicted likelihood for each of the categories and/or may include a single predicted category having the highest predicted likelihood.

The output from the categorical MLA may then be analyzed at step 320. The method 300 may proceed to different steps depending on what the output of the categorical MLA was. The recommended action having the highest predicted likelihood may be used to determine which step is next. If the recommendation with the highest predicted likelihood is to pause the campaign item or take no action, the method 300 may proceed to step 340. If the recommendation with the highest predicted likelihood is to create a new similar campaign item, the method 300 may proceed to step 325. If the recommendation with the highest predicted likelihood is to increase the budget or decrease the budget, the method 300 may proceed to step 330.

At step 325 a new similar campaign item may be generated. The new similar campaign item may be generated automatically, such as by identifying an aspect of the campaign item to change and modifying that aspect of the campaign item. Generative artificial intelligence (AI) may be used to modify the campaign item. The generative AI may be used to generate new text, audio, video, and/or images for the campaign item. In some implementations the new similar campaign item may be generated by a human operator, in which step 325 may be skipped and the new similar campaign item may be manually input by the operator at step 345. In either case, whether the new similar campaign item is generated automatically or manually, the method 300 may proceed to step 340.

At step 330 the campaign item may be input to a continuous MLA. The features used by the continuous MLA may be the same features as those used by the categorical MLA or different features. The output of the categorical MLA may be input as a feature to the continuous MLA.

The continuous MLA may be any type of MLA, such as a neural network. The continuous MLA may be the same type of MLA as the categorical MLA or a different type of MLA. The continuous MLA may be trained using similar training data as the categorical MLA. The continuous MLA may be trained using only training data points in which the budget for the training data point was increased or decreased. Instead of the label for the continuous MLA being categorical like the categorical MLA, the label for the continuous MLA may be a value indicating how much the budget for the training data point was increased or decreased. Each training data point may be input to the continuous MLA and a prediction may be output by the continuous MLA. The prediction may be compared to the label, and an amount of loss may be determined that indicates a difference between the prediction and the label. The continuous MLA may then be adjusted based on the amount of loss for the training data point.

At step 330 the continuous MLA may consider some or all of the features of the campaign item and/or the output of the categorical MLA. The continuous MLA may then output a value at step 335. The value may indicate a predicted amount to increase or decrease the budget of the campaign item. The method 300 may then proceed to step 340.

At step 340 the recommended action from steps 315 and/or 335 may be output to an operator. A user interface may be displayed to the operator. The user interface may include information about the campaign item and/or the recommendation for the campaign item. FIGS. 7 and 8 illustrate examples of a user interface that may be output to an operator. The user interface may allow the operator to accept the recommendation, decline the recommendation, and/or modify the recommendation. If the operator accepts the recommendation, the proposed changes will be applied to the campaign item. If the operator declines the recommendation, no changes will be made to the campaign item. If the operator chooses to edit the recommendation, the operator may make any changes to the campaign item. The operator may select a different amount to increase or decrease the budget, or select a different action from the recommended action. For example the recommendation may be to increase the budget for the campaign item, but the operator may choose to instead make no changes to the campaign item.

If the recommendation is to create a new similar campaign item, and the operator wishes to accept the recommendation, the operator may create the new similar campaign item. The operator may select which aspects of the campaign item they wish to modify in the new similar campaign item. If a new similar campaign item was automatically created at step 325, the operator may select whether they wish to accept the new similar campaign item that was generated or modify any aspects of the new similar campaign item.

At step 345 the operator's selection may be received. The user interface may be updated to indicate the operator's selection. Information about the campaign may be included in the user interface, such as a total price of the campaign. The total price of the campaign in the user interface may be updated based on the operator's selections. For example if the operator chooses to increase or decrease the budget for a campaign item, the total price of the campaign may be recalculated based on that change and the new total price for the campaign may be displayed to the operator. The displayed price may correspond to a time period, such as the next seven days, next thirty days, etc. The operator may select the time period.

At step 350 the operator's selection may be applied to the campaign. The operator's selection may be transmitted to the online service hosting the advertising campaign.

At step 355 an additional training data point may be generated based on the operator's selection. The additional training data point may include data about the campaign item, including performance data for the campaign item such as data related to clicks, impressions, views, and/or conversions. The label for the training data point may be the selection made by the operator. Two labels may be generated for the training data point, a categorical label and a continuous label. The categorical label may indicate whether the operator selected to increase the budget, decrease the budget, pause the campaign item, make no changes to the campaign item, generate a new similar campaign item, and/or any other selection made by the operator. The continuous label may indicate an amount that the operator chose to increase the budget or decrease the budget for the campaign item. If the operator selected to pause the campaign item, make no changes to the campaign item, or generate a new similar campaign item, the continuous label might not be generated, or may be a default value such as ‘1’ or ‘0’.

At step 360 the categorical MLA and/or continuous MLA may be further trained using the additional training data point. The categorical MLA and/or continuous MLA may be trained after each additional training data point is generated, after a pre-determined amount of training data points have been generated, after a pre-determined time period, after the operator selects to re-train the MLA, and/or at any other time. The categorical MLA and/or continuous MLA may then be used for further campaign management after being re-trained. In this manner the categorical MLA and/or continuous MLA can be continuously improved and can be responsive to changes in how human operators are managing campaigns.

### Training Data

FIG. 5 illustrates examples of training data 500 for training machine learning algorithms for managing a marketing campaign in accordance with various embodiments of the present technology. The training data may be used for training the categorical MLA and/or continuous MLA described in FIGS. 2-4. The training data 500 is illustrated in a table, but it should be understood that this is for exemplary purposes and that the training data 500 may be stored in any suitable format. Each row of the table corresponds to an individual training data point. Each of the columns corresponds to a feature of the training data points.

Feature 505 is a campaign ID of each training data point. The campaign ID may be any identifier of a campaign item, such as a name, identification number, and/or any other identifier. The campaign ID may indicate which other campaign items the campaign item is related to, such as if the campaign item has any parent campaign items and/or children campaign items. Alternatively, the related campaign items may be indicated in another feature or features (not illustrated).

Feature 510 indicates an amount of clicks that the campaign item has received. The amount of clicks may indicate the number of times that viewers clicked on, or otherwise selected, an advertisement corresponding to the campaign item. Feature 515 indicates a cost of the campaign. The cost may indicate how much the individual campaign item cost over a specified time period. Feature 520 indicates an amount of impressions for the campaign item. The amount of impressions may indicate the amount of times the advertisement corresponding to the campaign item was displayed to a viewer. Feature 525 indicates an amount of conversions for the campaign item. The amount of conversions may indicate the number of times a desired action was performed by a viewer. For example the amount of conversions may indicate an amount of times that a viewer of the advertisement corresponding to the campaign item purchased a product displayed in the advertisement. In another example the amount of conversions may indicate an amount of times that a user completed a form corresponding to the campaign item.

The amount of clicks, cost, amount of impressions, and/or amount of conversions may correspond to a specific time period. The time period may be a lifetime of the campaign item, the past thirty days, the past fourteen days, the past seven days, the past day, and/or any other time period. A user may be able to select the time period for each of the features 510, 515, 520, and 525. The features 510, 515, 520, and 525 may all correspond to the same time period and/or a different time period. Although not illustrated, multiple clicks, cost, impressions, or conversions features may be included, each having a different time period. For example the features for training data points could include clicks over the past thirty days, clicks over the past seven days, cost over the past thirty days, cost over the past seven days, impressions over the past thirty days, impressions over the past seven days, conversions over the past thirty days, and conversions over the past seven days.

Feature 530 indicates a cost per conversion. Like the features 510, 515, 520, and 525, the cost per conversion may correspond to a specified time period, such as past thirty days, past seven days, past day, etc. Multiple features related to cost per conversion may be included in a training data point, where each feature corresponds to cost per conversion over a different time period. Although not illustrated, other cost features may be included in each training data point, such as cost per click, cost per impression, etc. An exemplary list of features that may form a training data point is included below:
ID
Name
Parent ID
Parent name
Daily budget—maximum amount allocated to spend on the campaign each day
Experiment type—indicates whether the campaign includes any testing variations to optimize performance, such as A/B testing or any other type of testing
Bid strategy—whether the bids are set manually or automatically
Date campaign item was last edited
Date campaign item was created
Label—categorical
Label—continuous
Impressions—last 30 days
Impressions—last 7 days
Impressions—yesterday
Cost per conversion—last 30 days
Cost per conversion—last 7 days
Cost per conversion—yesterday
Clicks—last 30 days
Clicks—last 7 days
Clicks—yesterday
Conversions—last 30 days
Conversions—last 7 days
Conversions—yesterday
Conversion value—last 30 days
Conversion value—last 7 days
Conversion value—yesterday
Cost—last 30 days
Cost—last 7 days
Cost—yesterday

The training data points may include a categorical label 535 and/or a continuous label 540. Both labels 535 and 540 may indicate a selection that was made by an operator when reviewing a campaign item. The categorical label 535 may indicate which action the user selected for the campaign item, such as increasing the budget, decreasing the budget, creating a new similar campaign item, making no changes to the campaign item (i.e. continue), pausing the campaign item, and/or any other action that was selected corresponding to the campaign item. The continuous label may indicate an amount that the operator chose to modify the campaign item, such as an amount that the budget was increased or decreased. Some of the selections that an operator can make might not have any continuous data associated with the selection, such as creating a new similar campaign item, pausing a campaign item, making no changes to a campaign item, etc. In that case, the continuous label might not be included for a training data point or may be set to a default value, such as ‘0’ or ‘1’. In the exemplary training data 500, the continuous label ‘1’ corresponds to this default value.

Some or all of the training data 500 and/or the features and/or labels in the training data 500 may be used to train the categorical MLA and/or continuous MLA described in FIGS. 2-4. The two MLAs may be trained using the same features or different features. The label 535 may be used to train the categorical MLA, and the label 540 may be used to train the continuous MLA. When training the continuous MLA, training data points that do not include a continuous label and/or include a default value for the continuous label might not be used. In the training data 500, all five of the training data points may be used to train the categorical MLA. When training the continuous MLA the training data points having the campaign IDs 1 and 2 might be used to train the continuous MLA, whereas the training data points having the campaign IDs 3, 4, and 5 might not be used to train the continuous MLA. Although not illustrated in the training data 500, the output of the categorical MLA might be used as a feature or features when training the continuous MLA.

### Training the Machine Learning Algorithms

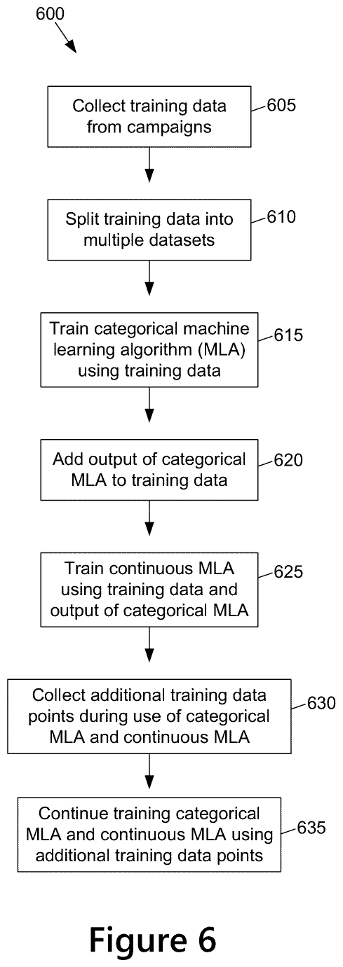

FIG. 6 is a flow diagram of a method 600 for training machine learning algorithms for managing a marketing campaign in accordance with various embodiments of the present technology. In one or more aspects, the method 600 or one or more steps thereof may be performed by a computing system, such as the computing environment 100. The method 600 or one or more steps thereof may be embodied in computer-executable instructions that are stored in a computer-readable medium, such as a non-transitory mass storage device, loaded into memory and executed by a CPU. The method 600 is exemplary, and it should be understood that some steps or portions of steps in the flow diagram may be omitted and/or changed in order.

At step 605 training data may be collected from campaigns. The training data may include any number of training data points, such as tens of thousands or hundreds of thousands of training data points. The training data may include any features, such as the features illustrated in FIG. 5.

At step 610 the training data may be split into multiple datasets. The training data may be split into a training dataset, a validation dataset, a testing dataset, and/or other datasets. The training data may be split in any manner, such as randomly. The datasets may be different sizes. For example 80% of the training data may be assigned to the training dataset, 10% of the training data may be assigned to the validation data set, and 10% of the training data may be assigned to the testing dataset. The training dataset may be used to train an MLA. The validation dataset may be used to evaluate a trained MLA, such as to estimate the accuracy of the MLA and/or adjust hyperparameters of the MLA. The test dataset may be used to verify the functionality of the MLA.

At step 615 the categorical MLA may be trained using the training data. Any suitable training method may be used to train the categorical MLA. As described above, the categorical MLA may be used to predict an action to be performed on a campaign item. The training dataset may be used to train the categorical MLA. The validation dataset may be used to adjust hyperparameters of the categorical MLA. The test dataset may be used to verify that the categorical MLA is sufficiently predictive to be ready for use.

At step 620 the output of the categorical MLA for each of the training data points that had a continuous label may be added to those training data points. For example, the output of the categorical MLA may be added as a feature to all of the training data points in which the action taken was to increase or decrease the budget of the campaign item.

At step 625 the continuous MLA may be trained using the training data points generated at step 620. Like with the categorical MLA, the training data for the continuous MLA may be split into a training dataset, test dataset, and/or validation dataset. As described above, the continuous MLA may be used to predict a magnitude of an action to be performed on a campaign item, such as an amount to increase or decrease the budget of the campaign item. The amount may be an actual amount, a percentage change, or any other indicator of a change to a campaign item. The training dataset may be used to train the continuous MLA. The validation dataset may be used to adjust hyperparameters of the continuous MLA. The test dataset may be used to verify that the continuous MLA is sufficiently predictive to be ready for use.

At step 630 additional training data points may be collected during use of the categorical MLA and/or continuous MLA. The additional training data points may include labels describing the selections made by an operator when the operator evaluated the campaign item corresponding to the training data point.

At step 635 the categorical MLA and/or continuous MLA may continue to be trained using the additional training data points.

### User Interfaces

FIG. 7 illustrates a user interface for reviewing recommendations and managing a marketing campaign in accordance with various embodiments of the present technology. The user interface in FIG. 7 includes a column 705 titled “Campaign item name,” a column 710 titled “Recommendation,” and a column 715 titled “Action.”

Each row of the table illustrated in FIG. 7 may correspond to an individual campaign item. The text in column 705 indicates a name of the campaign item. Any other identifying information regarding the campaign item may be included in the user interface, such as an image corresponding to the campaign item, text of the campaign item, information about other campaign items related to the campaign item, etc.

Column 710 indicates a recommendation for the campaign item. The information in column 710 may correspond to the output of the categorical MLA and/or continuous MLA. The information in column 710 may indicate the categorical recommendation for the campaign item, such as whether to increase the budget, decrease the budget, pause the campaign item, make no changes to the campaign item, create a new similar campaign item, and/or any other recommendation. The information in column 710 may indicate the continuous recommendation for the campaign item, such as an amount to increase or decrease the budget.

The column 715 may include action buttons or other selectable items for managing the campaign item. An operator may select whether they wish to accept the recommendation for the campaign item, reject the recommendation for the campaign item, and/or edit the action for the campaign item. If the operator makes a selection to accept the recommendation, the recommended action from the categorical MLA and/or continuous MLA may be applied to the campaign item. If the operator makes a selection to reject the recommendation, the campaign item may be left unchanged. If the operator makes a selection to edit the action, the operator may edit the actions to be applied to the campaign item. A new interface may be displayed if the operator selects to edit the campaign item, which allows the operator to select which action should be applied to the campaign item and/or an amount corresponding to the action, such as an amount to increase or decrease the budget of the campaign item. If the action chosen by the operator is to create a new similar campaign item, an interface may be displayed that allows the operator to create the new similar campaign item.

The interface may include a priority for each recommendation, such as high, medium, and low. The priority may indicate, to the user, an importance for applying the recommendation. The priority for a recommendation may be determined by analyzing features of the corresponding content item. The percentile of the value of a feature may be determined. The priority for a recommendation may be assigned based on the percentile positions of one or more features of the content item.

At the bottom of the user interface the change in cost 720 and total cost 725 may be displayed. The change in cost 720 may indicate a difference between the cost of the campaign prior to edits being made and the cost of the campaign after edits have been made. For example, if the operator selects to increase the budget of a campaign item, the change in cost 720 may increase to reflect that the cost of the campaign has increased. The total cost 725 may indicate the total cost of the campaign. The change in cost 720 and total cost 725 may dynamically adjust each time the operator makes a selection in the column 715, to reflect the changing cost of the campaign.

The change in cost 720 and total cost 725 may indicate a maximum cost of the campaign, projected cost of the campaign, and/or any other measure of the cost of the campaign. Any other indicators corresponding to the cost of the campaign may be included in the user interface. For example the operator may select a desired overall budget for the campaign, and the interface may indicate a difference between the desired overall budget and the projected cost. The change in cost 720 and/or total cost 725 may correspond to a specific time period, such as total cost over the next seven days. The operator may select the time period to be displayed.

FIG. 8 illustrates the user interface after selections have been made for managing the marketing campaign in accordance with various embodiments of the present technology. The interface of FIG. 8 is an example of the interface of FIG. 7 after an operator has made selections for each of the campaign items. Each of the cells in the column 715 now display which action has been selected for the campaign item. The change in cost 720 and total cost 725 have been updated to reflect the changes in cost corresponding to the selections. The user interfaces illustrated in FIGS. 7 and 8 may be continuously updated each time an operator makes a selection.

The user interfaces illustrated in FIGS. 7 and 8 are examples of user interfaces that may be used to review recommendations for an advertising campaign, modify recommendations from a system for managing an advertising campaign, such as the system illustrated in FIG. 2, and/or for controlling an advertising campaign. The user interface illustrated in FIGS. 7 and 8 are exemplary, and may include other information that is not illustrated, might not include some of the information that is illustrated, may include information in a different format or in a different arrangement than illustrated, and/or may otherwise be different from these illustrated exemplary interfaces.

While some of the above-described implementations may have been described and shown with reference to particular acts performed in a particular order, it will be understood that these acts may be combined, sub-divided, or re-ordered without departing from the teachings of the present technology. At least some of the acts may be executed in parallel or in series. Accordingly, the order and grouping of the act is not a limitation of the present technology.

It should be expressly understood that not all technical effects mentioned herein need be enjoyed in each and every embodiment of the present technology.

As used herein, the wording “and/or” is intended to represent an inclusive-or; for example, “X and/or Y” is intended to mean X or Y or both. As a further example, “X, Y, and/or Z” is intended to mean X or Y or Z or any combination thereof.

The foregoing description is intended to be exemplary rather than limiting. Modifications and improvements to the above-described implementations of the present technology may be apparent to those skilled in the art.

1. A method comprising:
retrieving data corresponding to a campaign item;
inputting the data corresponding to the campaign item to a first machine learning algorithm (MLA), wherein the first MLA was trained to predict a type of change to a campaign item based on first labelled campaign item data, wherein each data point in the first labelled campaign item data comprises data corresponding to a campaign item and a label comprising a categorical value indicating a type of change made to the campaign item;
receiving, from the first MLA, a first prediction, wherein the first prediction indicates a type of change for the campaign item;
inputting the data corresponding to the campaign item and the first prediction to a second MLA, wherein the second MLA was trained to predict a magnitude of the type of change to the campaign item based on second labelled campaign item data, wherein each data point in the second labelled campaign item data comprises data corresponding to a campaign item and a label comprising a numerical value indicating an amplitude of a change to the campaign item;
receiving, from the second MLA, a second prediction, wherein the second prediction indicates a magnitude corresponding to the first prediction;
outputting, to a user interface, the first prediction and the second prediction for display as a recommended action for the campaign item;
receiving, via the user interface, user input indicating whether the user has accepted the recommended action, rejected the recommended action, or modified the recommended action;
modifying the user interface based on the user input; and
applying, to the campaign item, changes from the user input.

2. The method of claim 1, further comprising
generating an additional training data point based on the user input; and
further training the first MLA and the second MLA using the additional training data point.

3. The method of claim 1, wherein retrieving the data corresponding to the campaign item comprises retrieving a number of clicks, a total cost, a number of impressions, and a number of conversions.

4. The method of claim 1, wherein the first MLA and the second MLA comprise neural networks.

5. The method of claim 1, wherein the categorical value of the label indicates that: no changes were made to the campaign item, a new similar campaign item was created, the campaign item was paused, a budget of the campaign item was increased, or the budget was decreased.

6. The method of claim 1, wherein the numerical value of the label indicates an amount that the campaign item budget was increased or decreased.

7. A method comprising:
retrieving data corresponding to a campaign item;
inputting the data corresponding to the campaign item to a machine learning algorithm (MLA), wherein the MLA was trained to predict a type of change to a campaign item based on labelled campaign item data, wherein each data point in the labelled campaign item data comprises data corresponding to a campaign item and a label comprising a categorical value indicating a type of change made to the campaign item;
receiving, from the MLA, a prediction indicating a type of change for the campaign item;
outputting, to a user interface, the prediction for display as a recommended action for the campaign item;
receiving, via the user interface, user input indicating whether the user has accepted the recommended action, rejected the recommended action, or modified the recommended action;
modifying the user interface based on the user input; and
applying, to the campaign item, changes from the user input.

8. A system comprising at least one processor and memory storing a plurality of executable instructions which, when executed by the at least one processor, cause the system to:
retrieve data corresponding to a campaign item;
input the data corresponding to the campaign item to a first machine learning algorithm (MLA), wherein the first MLA was trained to predict a type of change to a campaign item based on first labelled campaign item data, wherein each data point in the first labelled campaign item data comprises data corresponding to a campaign item and a label comprising a categorical value indicating a type of change made to the campaign item;
receive, from the first MLA, a first prediction, wherein the first prediction indicates a type of change for the campaign item;
input the data corresponding to the campaign item and the first prediction to a second MLA, wherein the second MLA was trained to predict a magnitude of the type of change to the campaign item based on second labelled campaign item data, wherein each data point in the second labelled campaign item data comprises data corresponding to a campaign item and a label comprising a numerical value indicating an amplitude of a change to the campaign item;
receive, from the second MLA, a second prediction, wherein the second prediction indicates a magnitude corresponding to the first prediction;
output, to a user interface, the first prediction and the second prediction for display as a recommended action for the campaign item;
receive, via the user interface, user input indicating whether the user has accepted the recommended action, rejected the recommended action, or modified the recommended action;
modify the user interface based on the user input; and
apply, to the campaign item, changes from the user input
